(19) United States
(12) Patent Application Publication
(10) Pub. No.: US 2017/0139661 A1
(43) Pub. Date: May 18, 2017

(54) Contextual Display State Management for Multi-Display Systems

(71) Applicant: Intel Corporation, Santa Clara, CA (US)

(72) Inventors: Karthik Veeramani, Hillsboro, OR (US); Kristoffer D. Fleming, Chandler, AZ (US); Paul S. Diefenbaugh, Portland, OR (US); Eugene Gorbatov, Hillsboro, OR (US)

(21) Appl. No.: 14/943,212

(22) Filed: Nov. 17, 2015

(51) Int. Cl. G06F 3/14; G01C 19/04; G06F 3/0354; G06F 3/041; G06F 3/02

(52) U.S. Cl. CPC G06F 3/1431; G06F 3/1454; G06F 3/041; G06F 3/02; G06F 3/03543; G01C 19/04

(57) ABSTRACT

In accordance with some embodiments, instead of always defaulting the primary display on or off, while mirroring its display to a secondary display, a sensor reading may be used to decide whether the primary display should be on or off. In other words, depending on a condition sensed by one or more sensors, a decision is made whether to turn the primary display on if the default setting is off or off if the default setting is on.

### BACKGROUND

A multi-display system includes a primary display that has its content mirrored or cloned to a secondary display over Wi-Fi. As an example, the user may have a display on the user's cellphone and when the user wirelessly connects either via a Wi-Fi network or an ad hoc wireless network, the content currently displayed on the user's cellular telephone (primary display) gets mirrored onto a larger display (secondary display) over the network or wirelessly accessible ad hoc network.

Typically in such multi-display systems, the primary display has a default on or off setting when the secondary display is activated. That means that the primary display is either always turned off or always turned on when in mirror mode.

### BRIEF DESCRIPTION OF THE DRAWINGS

Some embodiments are described with respect to the following figures:

FIG. 1 is a schematic depiction of one embodiment; and

FIG. 2 is a flow chart for one embodiment.

### DETAILED DESCRIPTION

In accordance with some embodiments, instead of always defaulting the primary display on or off, when in a mirror mode, a sensor reading may be used to decide whether the primary display should be on or off. In other words, depending on a condition sensed by one or more sensors, a decision is made whether to turn the primary display on if the default setting is off or off if the default setting is on.

Sometimes the user may mirror the primary display on a secondary display but may still prefer to also use the primary display, for example so that the user can input commands on the primary display, as one example.

A context aware primary display that is normally on in mirror mode may be turned off under certain circumstances. Likewise a primary display which is in mirror mode may be turned on even though its default setting is off. As an example, when a sensor detects that the primary display is face down, the sensor may turn a default on primary display in mirror mode off to reduce power consumption.

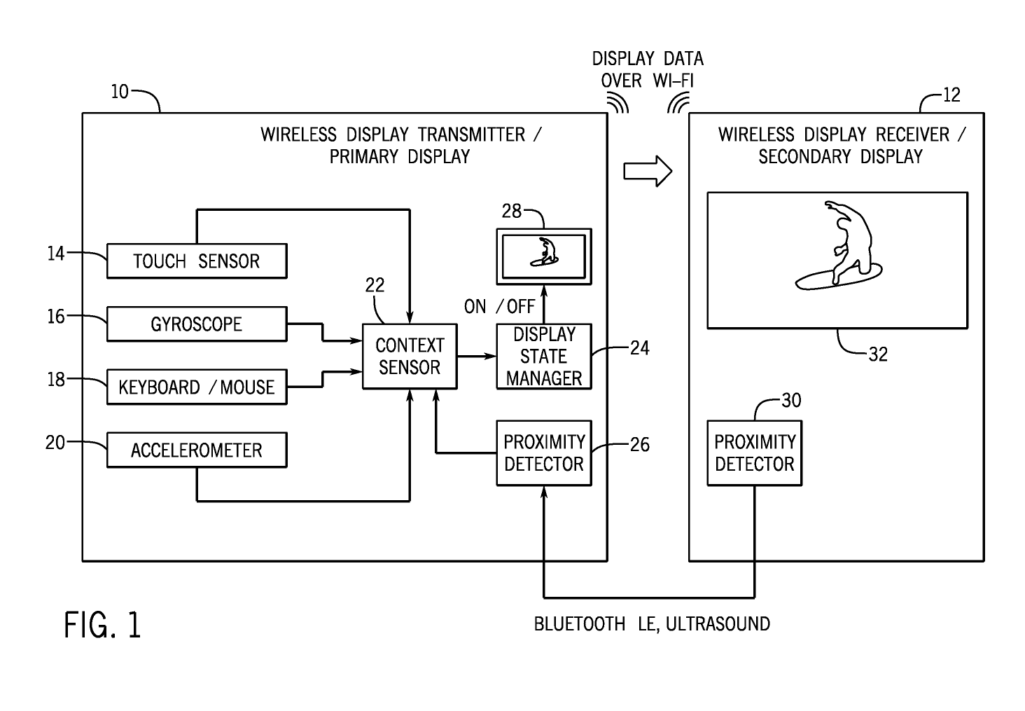

Referring to FIG. 1, in one embodiment, a wireless display transmitter, also called a primary display 10 may communicate display data over Wi-Fi to a wireless display receiver, also called the secondary display 12. The primary display includes a display 28 which may be on or off in mirror mode, a display state manager 24, and a proximity detector 26 that detects proximity to the secondary display 12.

In some embodiments, the primary device is a mobile device such as laptop, a tablet, a cellular telephone or a gaming device to mention a few examples. The secondary device can be any kind of display.

The wireless display transmitter and/or primary display 10 also includes a touch sensor 14, a gyroscope 16, a keyboard/mouse 18 and an accelerator 20. A context sensor 22 receives the inputs from the four sensors 14, 16, 18, and 20 and provides a consolidated signal to determine whether the default state of the primary display 28 should be changed under sensed conditions.

The primary display, which runs a wireless display transmitter software stack, shares its screen with a secondary display 32 running a wireless display receiver software stack. The transmitter stack contains a module called context sensor 22 that receives its inputs from one or more sensors 14, 16, 18, or 20 on the primary display 10.

An algorithm working with the context sensor combines one or more of these inputs and makes a decision whether or not to turn off the local display 28 when the local display is normally on or vice versa when the local display is normally off. The more sensor sources that provide inputs, the more accurate may be its decision with respect to changing the primary display's on or off state and the lower the impact on the user experience and power consumption. In one embodiment, power consumption is reduced to the greatest possible extent without inconveniencing the user when the user might prefer that the primary display is on.

The keyboard/mouse sensor 18 and touch sensor 14 may be used to decide whether to override a default setting of the display 28 when in mirror mode. For example, a touch sensor input received directly on the primary display 10 indicates that a user may intend to use the primary display 28. This causes the display that is normally off in mirror mode to turn on. Similarly, input from a keyboard/mouse sensed by keyboard/mouse 18 connected directly with the primary display 10 indicates the intention to use the primary display 28.

The accelerometer 20 may provide an input that indicates that the user is moving around with the primary display 10. While by itself, this input may not be sufficient to make a final decision, it can be useful in combination with other inputs. For example, the mere fact that the user is moving may mean that the user is moving with the primary display 10 in the user's pocket or in the user's hand.

The gyroscope 16 can indicate whether a device, like smartphone, is placed face up or face down. When the primary display 10 is face down, the user does not intend to use the primary display and a primary display that defaults on may be turned off.

The proximity detector 26 and its counterpart proximity detector 30 in the secondary display 12 may be connected by Bluetooth or ultrasound. By causing one of the primary secondary devices to emit an ultrasound frequency and then recording and analyzing the signal in the other of the two devices, it is determined when the two devices are in the same room. Ultrasound can be used in combination with a Bluetooth signal to minimize power consumption.

Once a transmitting device detects proximity of a receiver by communicating with its peer proximity detector on the receiver, it can feed this input into the context sensor. If the devices are not in the same room and the user is using the secondary display actively, this indicates that the user need not use the primary display. An accelerometer input can be combined with this information to add more accuracy to the decision. For example, this may allow eliminating the possibility that the user may be walking with the primary device in another room.

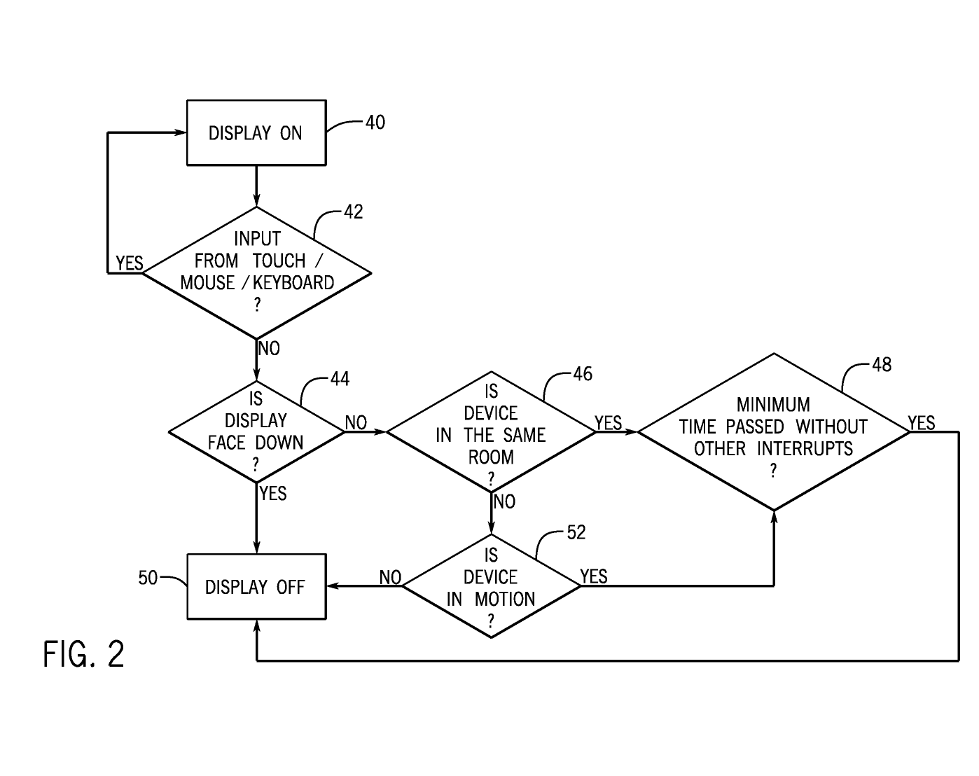

The sequence shown in FIG. 2 may be used to implement embodiments. The sequence may be implemented using software, firmware and/or hardware. In software and firmware embodiments it may be implemented using computer implemented instructions stored in one or more non-transitory computer readable medium such as a magnetic, optical or semiconductor storage.

The sequence shown in FIG. 2 begins by determining that the display is on and in the mirror mode, as indicated in block 40. When it receives an input from the touch/mouse/keyboard sensors, as indicated in diamond 42, it keeps the display on as indicated at block 40.

If no such input is received at diamond 42, then a check at diamond 44 determines whether the display is face down using information from the gyroscope. If the display is not face down, a check at diamond 46 determines if the device is in the same device in the same room as the secondary display. If so, a check at diamond 48 determines whether a minimum time period has passed without any other interrupts. If so, the display is turned off as indicated in block 50. If not, the flow ends.

If the device is in the same room as the secondary display as indicated in/at diamond 46, a check at diamond 52 determines whether the primary device is in motion. If not, the display is turned off as indicated in block 50 and otherwise a check at diamond 48 is used to decide how to handle a device being in motion. Namely at diamond 48 it is determined whether a minimum time has passed without interrupt, and if so, the display is turned off as indicated in block 50. If not, the flow ends.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

The following clauses and/or examples pertain to further embodiments:

One example embodiment may be a method comprising operating a primary display in mirror mode to wirelessly transmit content from said primary display for display on a secondary display, using at least two sensor inputs to said primary display to decide whether to turn said primary display off during mirror mode. The method may also include receiving a sensor input to indicate if the primary display is oriented with the primary display facing down. The method may also include using a gyroscope to detect the orientation of the primary display. The method may also include turning off the primary display when the primary display is face down. The method may also include determining proximity of said secondary display. The method may also include if the primary and secondary displays are not proximate determining whether the primary display is moving. The method may also include if the primary display is not moving, turning the primary display off. The method may also include if the primary display is moving determining if no new interrupt has occurred for a predetermined time period. The method may also include if no new interrupt occurs for said predetermined time period, turning off the primary display. The method may also include if the primary display and secondary displays are proximate, determining whether an interrupt occurs within a predetermined time period.

Another example embodiment may be one or more non-transitory computer readable media storing instructions to perform a sequence comprising operating a primary display in mirror mode to wirelessly transmit content from said primary display for display on a secondary display, and using at least two sensor inputs to said primary display to decide whether to turn said primary display off during mirror mode. The media may include said sequence including receiving a sensor input to indicate if the primary display is oriented with the primary display facing down. The media may include said sequence including using a gyroscope to detect the orientation of the primary display. The media may include said sequence including turning off the primary display when the primary display is face down. The media may include said sequence including determining proximity of said secondary display. The media may include said sequence if the primary and secondary displays are not proximate determining whether the primary display is moving. The media may include said sequence including if the primary display is not moving, turning the primary display off. The media may include said sequence said sequence including if the primary display is moving determining if no new interrupt has occurred for a predetermined time period. The media may include said sequence including if no new interrupt occurs for said predetermined time period, turning off the primary display. The media may include said sequence if the primary display and secondary displays are proximate, determining whether an interrupt occurs within a predetermined time period.

In another example embodiment may be an apparatus comprising a processor to operate a primary display in mirror mode to wirelessly transmit content from said primary display for display on a secondary display, to use at least two sensor inputs to said primary display to decide whether to turn said primary display off during mirror mode and a memory coupled to said processor. The apparatus may include said processor to receive a sensor input to indicate if the primary display is oriented with the primary display facing down. The apparatus may include said processor to use a gyroscope to detect the orientation of the primary display. The apparatus may include said processor to turn off the primary display when the primary display is face down. The apparatus may include said processor to determine proximity of said secondary display. The apparatus may include said processor to, if the primary and secondary displays are not proximate, determine whether the primary display is moving. The apparatus may include said processor to, if the primary display is not moving, turn the primary display off. The apparatus may include said processor to, if the primary display is moving, determine if no new interrupt has occurred for a predetermined time period. The apparatus may include said processor to, if no new interrupt occurs for said predetermined time period, turn off the primary display. The apparatus may include said processor to, if the primary display and secondary displays are proximate, determine whether an interrupt occurs within a predetermined time period.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
operating a primary display in mirror mode to wirelessly transmit content from said primary display for display on a secondary display; and
using at least two sensor inputs to said primary display to decide whether to turn said primary display off during mirror mode.

2. The method of claim 1 including receiving a sensor input to indicate if the primary display is oriented with the primary display facing down.

3. The method of claim 2 including using a gyroscope to detect the orientation of the primary display.

4. The method of claim 2 including turning off the primary display when the primary display is face down.

5. The method of claim 1 including determining proximity of said secondary display.

6. The method of claim 5 including if the primary and secondary displays are not proximate determining whether the primary display is moving.

7. The method of claim 6 including if the primary display is not moving, turning the primary display off.

8. The method of claim 6 including if the primary display is moving determining if no new interrupt has occurred for a predetermined time period.

9. The method of claim 8 including if no new interrupt occurs for said predetermined time period, turning off the primary display.

10. The method of claim 6 including if the primary display and secondary displays are proximate, determining whether an interrupt occurs within a predetermined time period.

11. One or more non-transitory computer readable media storing instructions to perform a sequence comprising:
operating a primary display in mirror mode to wirelessly transmit content from said primary display for display on a secondary display; and
using at least two sensor inputs to said primary display to decide whether to turn said primary display off during mirror mode.

12. The media of claim 11, said sequence including receiving a sensor input to indicate if the primary display is oriented with the primary display facing down.

13. The media of claim 12, said sequence including using a gyroscope to detect the orientation of the primary display.

14. The media of claim 12, said sequence including turning off the primary display when the primary display is face down.

15. The media of claim 11, said sequence including determining proximity of said secondary display.

16. The media of claim 15, said sequence including if the primary and secondary displays are not proximate determining whether the primary display is moving.

17. The media of claim 16, said sequence including if the primary display is not moving, turning the primary display off.

18. The media of claim 16, said sequence including if the primary display is moving determining if no new interrupt has occurred for a predetermined time period.

19. The media of claim 18, said sequence including if no new interrupt occurs for said predetermined time period, turning off the primary display.

20. The media of claim 16, said sequence including if the primary display and secondary displays are proximate, determining whether an interrupt occurs within a predetermined time period.

21. An apparatus comprising:
a processor to operate a primary display in mirror mode to wirelessly transmit content from said primary display for display on a secondary display, to use at least two sensor inputs to said primary display to decide whether to turn said primary display off during mirror mode; and
a memory coupled to said processor.

22. The apparatus of claim 21, said processor to receive a sensor input to indicate if the primary display is oriented with the primary display facing down.

23. The apparatus of claim 22, said processor to use a gyroscope to detect the orientation of the primary display.

24. The apparatus of claim 22, said processor to turn off the primary display when the primary display is face down.

25. The apparatus of claim 21, said processor to determine proximity of said secondary display.

26. The apparatus of claim 25, said processor to, if the primary and secondary displays are not proximate, determine whether the primary display is moving.

27. The apparatus of claim 26, said processor to, if the primary display is not moving, turn the primary display off.

28. The apparatus of claim 26, said processor to, if the primary display is moving, determine if no new interrupt has occurred for a predetermined time period.

29. The apparatus of claim 28, said processor to, if no new interrupt occurs for said predetermined time period, turn off the primary display.

30. The apparatus of claim 26, said processor to, if the primary display and secondary displays are proximate, determine whether an interrupt occurs within a predetermined time period.
